(19) United States
(12) Patent Application Publication
(10) Pub. No.: US 2012/0161928 A1
(43) Pub. Date: Jun. 28, 2012

(54) Display Apparatus, Remote Controller and Associated Display System

(75) Inventors: Kun-Nan Cheng, Hsinchu Hsien (TW); Chieh-Huang Tu, Hsinchu Hsien (TW)

(73) Assignee: MSTAR SEMICONDUCTOR, INC., Hsinchu Hsien (TW)

(21) Appl. No.: 13/190,651

(22) Filed: Jul. 26, 2011

(30) Foreign Application Priority Data
Dec. 24, 2010 (TW) 099145930

(51) Int. Cl. G05B 11/01; G08B 5/22

(52) U.S. Cl. 340/6.1; 340/12.52

(57) ABSTRACT

A display apparatus, remote controller and associated display system are provided. A plurality of peripheral apparatuses is controlled by a universal remote controller according to a remote control signal from the remote controller. The display apparatus displays a remote control menu respectively corresponding to the different peripheral apparatuses, so as to offer the universal remote control with a rich, intuitive and user-friendly user interface.

This application claims the benefit of Taiwan application Serial No. 99145930, filed Dec. 24, 2010, the subject matter of which is incorporated herein by reference.

### BACKGROUND OF THE INVENTION

1. Field of the Invention

The invention relates in general to a display apparatus, remote controller and associated display system, and more particularly to a display apparatus, remote controller and associated display system with a user-friendly user interface that realizes universal remote control by utilizing operating resources of the display apparatus.

2. Description of the Related Art

Multimedia information contains video and audio information recording a diversity of events associated with creativity, knowledge, activities and news that can be displayed by multimedia information display apparatuses including televisions, monitors and projectors, among others, which have effectively become essential electronic devices in modern society.

To offer a true-to-life display quality and a user-friendly display environment, a display apparatus generally operates with various peripheral apparatuses to form a display system. The peripheral apparatuses include signal source devices of multimedia information such as video tapes, DVD and/or blue-ray disc players, memory/hard-disc players, satellite/network/wired and/or wireless TV set-up boxes, video game consoles, mobile phones, computers and cameras with multimedia output functions, and camcorders. Peripheral apparatuses can also be auxiliary playback devices such as speakers, equalizers and amplifiers. Other types of peripheral apparatuses are those for receiving output of display apparatuses, such as audio tape, video tape and/or optical disk recorders. Further, peripheral apparatuses can still also include devices that adjust ambient background, from air-conditioning devices, heaters, lighting of adjustable brightness, windows/curtains controllable by servers, windows with adjustable transparency, to even a controllable projection curtain when the display apparatus is a projector.

Modernized display apparatuses and peripheral apparatuses can often be controlled by remote controllers; however, these remote controllers are dedicated for respective display apparatuses and peripheral apparatuses, such that one is only too familiar with the inconveniences incurred when trying to operate the different remote controllers for switching between the corresponding apparatuses. For example, in order to enjoy multimedia information from an optical disk, it is essential that a user activate an optical disk player to start the playback of the multimedia information using an optical disk remote controller, switch a signal source to the optical disk player using a display apparatus remote controller to display the multimedia information, and/or power on and adjust the volume of the multimedia information using an audio remote controller, adjust or switch off lighting using a light remote controller, and adjust the room temperature using an air-conditioner remote controller.

Attempts have been made to provide universal remote controllers that integrate various remote controllers of a display system. However, such universal remote controllers nevertheless suffer from certain drawbacks. For example, to indicate corresponding remote functions of buttons on a remote controller, the buttons are complemented with graphics, symbols, texts, colors and/or shapes of the buttons to provide more intuitive identification tips for users; also, buttons of the universal remote controller are utilized to replace those of dedicated remote controllers. However, positions, arrangements and indication tips of the universal remote controller are unlikely to be consistent with those of the dedicated remote controllers, such that one must adapt and/or memorize the positions, arrangements and indication tips of the universal remote controller in order to operate the universal remote controller instead of operating according to user-friendly, intuitive manipulations. The identification tips of the buttons of the dedicated remote controllers are designed solely based on user intuitions, and those of the universal remote controller, in comparison, appear as more generalized and less distinctive since they are defined to support less specific functions.

Further, the identification tips of the buttons of the universal remote controller are rather fixed. For example, although a power-on button on the dedicated remote controller can be programmed to correspond to different buttons on the universal remote controller, the identification tips of the buttons on the dedicated remote controller cannot be user-defined as desired to again lead to user operation complications.

### SUMMARY OF THE INVENTION

The invention is directed to a solution for a universal remote control mechanism. According to the present invention, a display unit of a display apparatus displays remote control menus of various dedicated remote controllers (including positions, arrangements and/or button identification tips), and also provides editable user-defined remote control menus, so as to realize a user-friendly and intuitive universal remote control mechanism and operating environment.

It is an objective the present invention to provide a display apparatus, which is connected with a plurality of peripheral apparatuses and is utilized to display media signals from the peripheral apparatuses. The display apparatus comprises a receiver, a remote control processing module, an input interface and a display unit. The receiver receives a remote control signal. The remote control processing module, coupled to the receiver, provides a remote control menu to correspond to the peripheral apparatuses. The input interface receives the media signals of multimedia information from the peripheral apparatuses. The display apparatus, coupled to the remote control processing module and the input interface, displays the media signals and the remote control menu in response to the remote control signal to generate a remote control operation corresponding to the peripheral apparatuses.

In an embodiment, the display apparatus further comprises a menu recorder coupled to the remote control processing module to record a corresponding coordinate arrangement for the remote control menu. The coordinate arrangement comprises a plurality of coordinate regions, and a plurality of corresponding remote control commands each associated with a corresponding peripheral apparatus. The remote control processing module comprises a graphic generating unit for providing a corresponding graphic to each coordinate region, so as to allow the display unit to display the remote control menu. The remote control menu, editable via the remote control signal, has its different coordinate regions respectively correspond to the remote control signals of the different peripheral apparatuses, e.g., a power-on signal. Further, different remote control menus may correspond to dedicated remote controllers of different peripheral apparatuses to display buttons positions and identification tips of the dedicated remote controllers. The coordinate regions on the remote control menus represent the buttons on the dedicated remote controllers corresponding to the remote control commands of the peripheral apparatuses. The remote control menus may also be user-defined and user-editable.

The remote control signal may be transmitted from a remote controller. In another embodiment, the receiver in the display apparatus is an image receiver (e.g., an optical sensor or an image recorder) to capture user motion characteristics as a remote control signal so that a user is allowed to remote control via gestures or motions. And/Alternatively, the receiver is an audio receiver (e.g., a microphone) that captures characteristics from a user sound (e.g., a speech or hand-clapping) as a remote control signal to achieve audio control.

In an embodiment, the remote control carries coordinate information, and the remote control processing module further comprises a coordinate calculator and an indication module. The coordinate calculator is coupled to the receiver, and the indication module is coupled to the coordinate calculator. When the display unit displays a current remote control menu, the coordinate calculator compares the coordinate information and coordinate regions with a coordinate arrangement corresponding to the current remote control menu. When the coordinate calculator determines that the coordinate information matches a predetermined matching coordinate region, it means that triggering a remote control command corresponding to the coordinate region is desired, such that the indication module provides a transmission signal according to the remote control command corresponding to the matching coordinate region to carry the remote control command in the transmission signal. The display apparatus further comprises a transmitter for transmitting the transmission signal to the peripheral apparatus associated with the remote control signal.

In an embodiment, the transmitter in the display apparatus directly transmits the transmission signal to the peripheral apparatuses. In another embodiment, the transmitter in the display apparatus first transmits the transmission signal carrying the remote control command to a remote controller, which then relays the received transmission signal to the peripheral apparatuses. In yet another embodiment, the transmission signal from the transmitter in the display apparatus is transmitted to the peripheral apparatuses via one or a plurality of relay apparatuses, one of which may be a remote controller supporting relay functions.

In an embodiment, the remote control signal carries command information, and the remote control processing module further comprises a command comparator coupled to the receiver. The command comparator compares the command information with a plurality of remote control commands each corresponding to a peripheral apparatus. When the command comparator determines the command information in the remote control signal matches a predetermined matching remote control command, the indication module provides the transmission signal according to the matching remote control command.

It is another objective of the present invention to provide a remote controller for remote controlling a display apparatus and a plurality of peripheral apparatuses. The remote controller comprises a plurality of function keys, a transmitter, a controller and a receiver. The transmitter transmits a remote control signal to the display apparatus. The receiver receives from the display apparatus a first transmission signal corresponding to the remote control signal. The controller, coupled to the transmitter and the receiver, provides a corresponding second transmission signal according to the first transmission signal, and the transmitter further transmits the second transmission signal.

In an embodiment, the controller comprises a recorder and a transmission generator. The recorder is coupled to the receiver, and the transmission generator is coupled to the transmitter and the recorder. The recorder provides first transmission information according to the transmission signal, according to which the transmission generator provides the second transmission signal. For example, the recorder is a waveform recorder that provides/records the first transmission information according to waveform characteristics of the first transmission signal (e.g., waveform samples of the first transmission signal); the transmission generator is a waveform generator that reconstructs the second transmission signal according to the waveform characteristics recorded in the first transmission information.

The remote controller further comprises a coordinate generator and/or a command generator. The coordinate generator is coupled to the transmission generator, and the command generator is also coupled to the transmission generator. According to a received user control, the coordinate generator generates coordinate information and the command generator provides corresponding command information. The transmission generator provides the remote control signal according to the coordinate information and the command information to the transmitter. The coordinate generator and/or command generator receive a user control via the buttons on the remote controller, a touch panel and/or via a relay mechanism, so as to provide the corresponding coordinate information/command information according to the user control. And/Alternatively, the coordinate generator and/or the command generator receive user motions, gestures and/or audio control via an image receiver and/or an audio receiver.

It is yet another objective of the present invention to provide a display system comprising a plurality of peripheral apparatuses, a display apparatus and a remote controller. The display apparatus comprises a display unit, a first receiver and a first transmitter. The first receiver receives a remote control signal to set a remote control menu. The first transmitter transmits a first remote control signal according to the remote control signal. The display apparatus displays a media signal from the peripheral apparatuses and the remote control menu. The remote controller for remote controlling the display apparatus comprises a plurality of function keys, a second receiver, a second transmitter and a coordinate generator. The second receiver receives the first transmission signal. The second transmitter transmits the remote signal, and transmits a second transmission signal to the peripheral apparatuses according to the first transmission signal. The coordinate generator provides coordinate information of the function keys. The remote control signal is associated with the coordinate information, and the remote control menu is associated with the coordinate information and the peripheral apparatuses.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIGS. 1 to 3 are schematic diagrams of different embodiments according to the present invention.

### DETAILED DESCRIPTION OF THE INVENTION

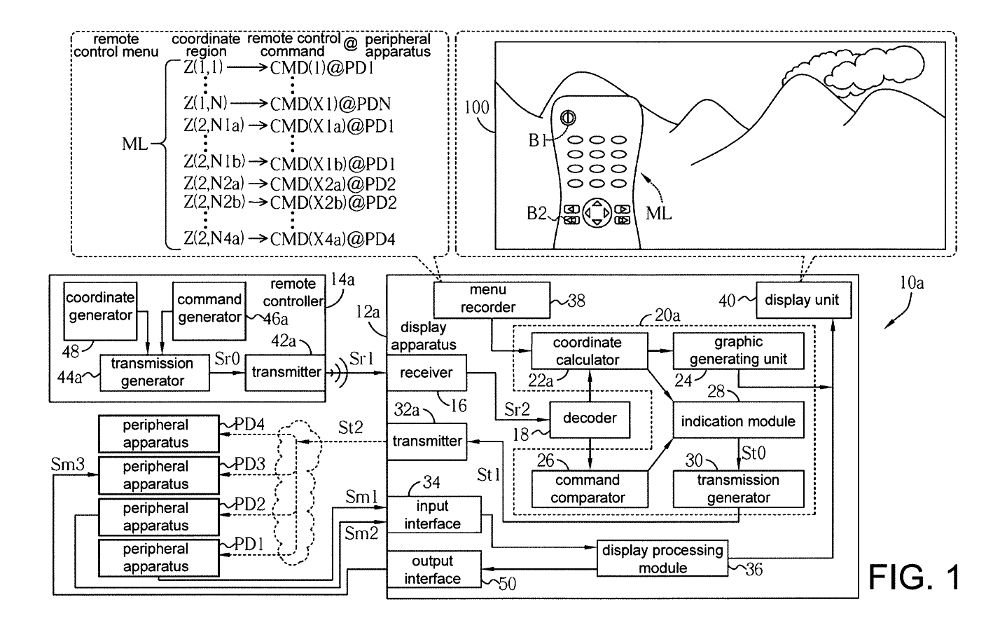

FIG. 1 shows a schematic diagram of a display system 10a according to an embodiment of the present invention. The display system 10a comprises a display apparatus 12a, a remote controller 14a, and at least one peripheral apparatus. In FIG. 1, peripheral apparatuses PD1 to PD4 are taken as an example. For example, the display apparatus 12a is a television, a monitor or a projector; the peripheral apparatuses PD1 and PD2 are signal source devices of multimedia information respectively providing multimedia signals Sm1 and Sm2 (e.g., streams carrying video and audio multimedia information) to the display apparatus 12a; the peripheral apparatus PD3 is an audio or video recording device that receives a media signal Sm3 output from the display apparatus 12a; and the peripheral apparatus PD4 is an auxiliary playback device such as a sound system or a speaker, or a device for adjusting an ambient environment of the display device such as a controllable air-conditioner, curtains or lighting. According to the present invention, the remote controller 14a can be utilized to universally remote control the display apparatus 12a and the peripheral apparatuses PD1 to PD4 so that the display apparatus 12a serves as a user interface of universal remote control to provide a rich, intuitive and user-friendly operating environment.

In the display system 10a, the display apparatus 12a comprises a receiver 16, a decoder 18, a remote control processing module 20a, an input interface 34, a display processing module 36, a menu recorder 38, a display unit 40, and an output interface 50. The remote control processing module 20a comprises a coordinate calculator 22a, a graphic generating unit 24, a command comparator 26, an indication module 28, and a transmission generator 30. The coordinate calculator 22a and the command comparator 26 disposed in the remote control processing module 20 are coupled to the receiver 16 via the decoder 18, and are also coupled to the indication module 28. The indication module 28 is coupled to the transmission generator 30, and then coupled to the transmitter 32a. The menu recorder 38 is coupled to the coordinate calculator 22a in the remote control processing module 20a, and then coupled to the graphic generating unit 24. The display unit 40 is coupled to the input interface 50 via the display processing module 36, and is also coupled to the graphic generating unit 24 in the remote control processing module 20a.

The remote controller 14a comprises a transmitter 42a, a transmission generator 44a, a command generator 46a, and a coordinate generator 48. The command generator 46a and the coordinate generator 48 are coupled to the transmission generator 44a, and then coupled to the transmitter 42a.

In the display apparatus 12a, the input interface 34 is coupled to the peripheral apparatuses PD1 and PD2 to respectively receive the media signals Sm1 and Sm2. The display processing module 36 is coupled to the input interface 34 and the display unit 40. The display processing module 36 demodulates, restores, decodes, decompresses and/or performs other signal processing operations on the media signals received by the input interface 34, so as to retrieve images carried by the media signals and display the retrieved images on the display unit 40. The display unit 40 comprises, e.g., a display panel and associated control driving mechanisms. Further, the peripheral apparatus PD3 that receives signals from the display apparatus 12a may be coupled to the output interface 50. Results of signal processing by the display processing module 36 are then output as a media signal Sm3 from the output interface 50 and then transmitted to the peripheral apparatus PD3.

In the display system 10a according to the present invention, how the display apparatus 12a and the remote controller 14a realize universal remote control and a corresponding user interface is to be described below.

In the remote controller 14a, the coordinate generator 48 receives a user control to provide coordinate information, and the command generator 46a provides corresponding command information under the user control. For example, the coordinate generator 48 and the command generator 46a receive a user control via function keys (e.g., buttons, a touch panel and/or a rotating wheel) on the remote controller 14a, and accordingly provide the corresponding coordinate information and command information. The transmission generator 44a provides an electronic control signal Sr0 to the transmitter 42a according to the coordinate information and command information. For example, the transmission generator 44a encodes/packages the coordinate information and command information in the remote control signal Sr0. The transmitter 42a then converts/modulates the remote control signal Sr0 to a remote control signal Sr1 and transmits the remote control signal Sr1. For example, the remote control signal Sr1 is an infrared or radio frequency remote control signal.

In the display apparatus 12a, the receiver 16 receives and demodulates/de-converts the remote control signal Sr1 to an electronic remote control signal Sr2. The decoder 18 decodes/de-packages the coordinate information and command information carried by the remote control signal Sr2. The command comparator 26, embedded with a plurality of predetermined/default remote control commands, compares the command information in the remote control signal Sr2 with the predetermined remote control commands. The remote control commands may be remote control commands of the display apparatus 12a, or further include remote control commands acceptable to the peripheral apparatuses PD1 to PD4; in other words, the remote control commands correspond to the display apparatus 12a or one of the peripheral apparatuses PD1 to PD4.

When the comparator 26 determines that the command information in the remote control signal Sr2 matches with a matching remote control commands from the predetermined remote control commands, the display apparatus 12a operates according to the matching remote control command in the event that the matching remote control command is one of the remote control commands of the display apparatus 12a. On the other hand, in the event that the matching remote control signal corresponds to one of the peripheral apparatuses, the indication module 28 provides a transmission signal St0 according to the matching remote control command. For example, the matching remote control signal is carried in the transmission signal St0. The transmission generator 30 encodes/packages the transmission signal St0 as a transmission signal St1, which is converted/modulated to a transmission signal St2 by the transmitter 32a that then transmits the transmission signal St2.

In the embodiment shown in FIG. 1, the transmitter 32a realizes a transmission interface between the display apparatus 12a and the peripheral apparatuses PD1 to PD4. For example, the transmitter 32a is an infrared or radio frequency transmitter that transmits an infrared/radio frequency transmission signal St2 to the peripheral apparatuses. Thus, the peripheral apparatus corresponding to the remote control command in the transmission signal St2 receives the remote control signal and is triggered to perform a corresponding operation. As another example, the transmitter 32a transmits the transmission signal St2 to the peripheral apparatuses via a wired or wireless network so that the corresponding peripheral apparatus receives the remote control command in the transmission signal St2. In this network, the display apparatus 12a and the peripheral apparatuses are connected to form a network by star topology or daisy chain topology. Being transmitted via the transmitter 42a in the remote controller 14a and the receiver 16 in the display apparatus 12a to the transmitter 32a, the corresponding remote control command is received by all of the display apparatus 12a and the peripheral apparatuses PD1 to PD4 to realize universal remote control.

To offer a richer, more intuitive and user-friendly remote control user interface, the remote control processing module 36 further provides various remote control menus, which simulate dedicated remote controllers of the peripheral apparatuses and the display apparatus 12a using graphics, so that one may perform universal remote control with remote control operation concepts and intuitions inherited from the dedicated remote controllers. In the embodiment, the menu recorder 38 in the display apparatus 12a is for storing a remote control menu ML. According to the remote control menu ML provided by the menu recorder 38, the graphic generating unit 24 generates a corresponding graphic to be displayed on the display unit 40. The screen 100 in FIG. 1 shows a graphic displayed by the display unit 40. The remote control menu ML comprises a coordinate arrangement consisting one or a plurality of coordinate regions, and each coordinate region corresponds to one or a plurality of remote control commands each associated with a predetermined peripheral apparatus or the display apparatus 12a. In the screen displayed on the display unit 40, different positions are assigned with different coordinates in a way that each coordinate corresponds to a predetermined region on the displayed screen.

For example, the remote control menu ML comprises N1 coordinate regions Z(1,1) to Z(1,N) for serving as a first-tier remote control interface of the peripheral apparatuses PD1 to PD4, and the coordinate regions Z(1,1) to Z(1,N) respectively correspond to select buttons of the different peripheral apparatuses PD1 to PD4. For example, the peripheral apparatus PD1 is activated upon triggering a corresponding remote control command CMD(1) by pressing the coordinate region Z(1,1). After activating the peripheral apparatus PD1, a second-tier remote control menu ML is entered. This second-tier remote control menu simulates button positions and arrangements and identification tips of the dedicated remote controller of the peripheral apparatus PD1 (e.g., a DVD player). The coordinate regions Z(2,Na1) to Z(2,N1b) of the second-tier remote control menu respectively correspond to buttons (or an operable control mechanism) on the dedicated remote controller, so that each of the coordinate regions Z(2,Na1) to Z(2,N1b) respectively correspond to remote control commands CMD(X1a) to CMD(X1b) receivable by the peripheral apparatus PD1. In one example, the remote control command CMD(X1a) is a power-off command, and the remote control command CMD(X1b) is a fast-forward command. When the remote control menu ML is displayed on the screen 100, the coordinate regions are represented as graphics of corresponding buttons. For example, a graphic B1 of a button corresponds to the coordinate region Z(1,1), and a graphic B2 corresponds to the coordinate region Z(2,N1b). Similarly, to correspond to a dedicated remote controller of the peripheral apparatus PD2, the remote control menu ML further comprises a plurality of coordinate regions Z(2,N2a) to Z(2,N2b) to respective correspond to remote control commands CMD(X2a) to CMD(X2b) of the peripheral apparatus PD2. It is to be appreciated that in another embodiment of the present invention, the display apparatus may also have a single-tier remote control menu.

Via the user interface realized by the remote control menu, universal remote control by utilizing the remote controller 14a is to be elaborated below. According to guidance of the instructions shown on the screen of the display unit 40, the user controls the coordinate generator 48 in the remote controller 14a to generate coordinate information that corresponds to a position on the image. The coordinate information is carried in the remote control signals Sr0, Sr1 and Sr2 and is transmitted to the coordinate calculator 22a, which then informs the user a corresponding position of the coordinate information via the graphic generating unit 24 and the display unit 40. For example, graphic generating unit 24 provides a cursor graphic at a corresponding position of the coordinate information to display on the screen of the display unit 40. Alternatively, for the coordinate regions of the remote control menus, the coordinate calculator 22a calculates and determines a coordinate region most approximate to the corresponding position of the coordinate information, and updates the coordinate information to the coordinate region; the graphic generating unit 24 may then highlight the corresponding graphic of the coordinate region through a brighter or dynamic image.

The coordinate calculator 22a in the display apparatus compares the user coordinate information with the coordinate regions of the remote control menu. When the coordinate calculator 22a determines that the coordinate information matches a predetermined matching coordinate region, it means that triggering the remote control command corresponding to the matching coordinate region is desired. Supposing the remote control command corresponds to a peripheral apparatus, the indication module 28 provides the transmission signal St1 according to the remote control command corresponding to the coordinate region, and has the remote control command carried in the transmission signal St1. The transmitter 32a in the display apparatus then transmits the transmission signal St2 to the peripheral apparatuses according to the transmission signal St1.

In other words, with the remote controller 14a, the user can freely switch between the coordinate regions of the remote control menu to respectively remote control different peripheral apparatuses. Since the remote control menu may inherit button configurations as well as identification tips of the dedicated remote controllers, the user does not need to adapt himself to the original physical button configurations or identification tips of the remote controller 14a. It is to be noted that the display functions and software/hardware operation resources of the display apparatus 12a are far richer than those of the remote controller 14a. Partial functions such as the user interface of universal remote control are realized by existing functions and operation resources of the display apparatus 12a. Also, the present invention simplifies a physical structure of the remote controller 14a since a user interface is not required at the remote controller end to reduce cost. Further, the display apparatus 12 enhances the universal remote control by providing more diversified remote control functions to better meet user needs.

For example, configurations of the dedicated remote controllers may be reinforced as desired by the user. For example, if the user feels that a certain button of a dedicated remote controller is frequently used, a coordinate region and a graphic corresponding to the frequently used button may be user-defined to make it more distinct or more easily triggered. Conversely, buttons that are less frequently used can be removed from the remote control menu. Better yet, coordinate regions of the remote control menus may be associated with corresponding sound effects to further provide video and audio feedbacks from the remote control menus.

With the remote control menu ML, besides simulating the dedicated remote controllers of the peripheral apparatuses, the remote control commands of the peripheral apparatuses as well as the display apparatus 12a can be collectively managed. For example, remote control commands needed for watching a movie can be put together in the remote control menu ML, such as associating a coordinate region Z(2,N4a) with a predetermined remote control command CMD(X4a) of the peripheral apparatus PD4 (e.g., for power-on or temperature adjustment) to adjust a movie watching environment.

As shown on the screen 100, the remote control menu ML can be displayed at a same screen with an image provided by the display processing module 36. Supposing no remote control is performed for a predetermined period, the remote control module 36 automatically hides the graphic of the remote control menu ML. The remote control menu ML only re-appears the next time remote control is performed. Further, the transparency of the graphic of the remote control menu ML may also be user-adjustable.

In another embodiment of the present invention, the screen may display graphics of a plurality of remote control menus ML(1) to ML(n) (not shown) as remote control menus of different apparatuses. Alternatively, texts, symbols and/or graphics may also be user-defined to briefly describe functions (i.e., remote control commands) corresponding to the coordinate regions. In other words, the user-defined remote control menu is similar to a macro to enable the user to collectively manage frequently used remote control commands of different peripheral apparatuses for easy access.

In the embodiment in FIG. 1, when remote control is initiated via the remote controller 14a, the remote control signal Sr1 is transmitted by the transmitter 42a, and is then received as an electronic remote control signal Sr2 by the receiver 16 in the display apparatus 12a in conjunction with the transmitter 42a. In another embodiment, the receiver 16 may include an image receiver, e.g., an optical sensor or an image recorder, to directly capture user motion characteristics as the coordinate information and/or command information in the remote control signal Sr2, such that universal remote control is performed by user gesture and/or motion. In this embodiment, a physical remote controller 14a is no longer required since the user gesture and/or motion realizes functions of a virtual remote controller. And/Alternatively, the receiver may comprise an audio receiver (e.g., a microphone) to capture characteristics from a user sound (e.g., a speech or a hand clapping sound) as the coordinate information and/command information to realize audio universal remote control.

Likewise, the coordinate generator 48 and/or the command generator 46a in the remote controller 14a may also accept user motion, gesture, and/or audio control via a video receiver and/or an audio receiver to generate corresponding coordinate information and/or command information. In certain applications, the display apparatus 12a may be distantly located from the user, and so the physical remote controller 14a is placed near the user to readily capture a user motion, gesture and/or sound.

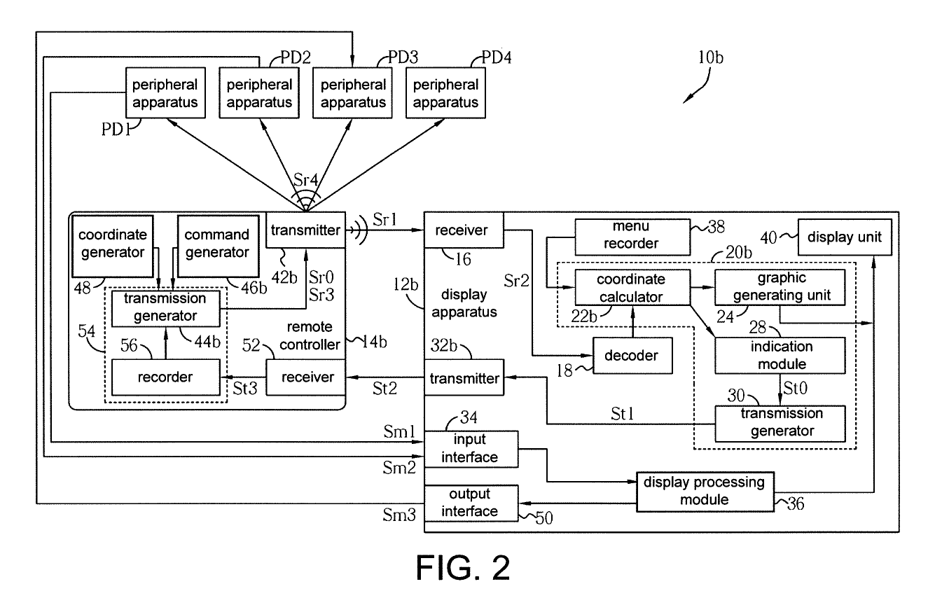

FIG. 2 shows a schematic diagram of a display system 10b according to another embodiment of the present invention. In the display system 10b, universal remote control is performed with respect to a display apparatus 12b and a plurality of peripheral apparatuses (e.g., PD1 to PD4) using a remote controller 14b. Similar to the display apparatus 10a shown in FIG. 1, the display system 10b in FIG. 2 comprises a receiver 16, a decoder 18, a menu recorder 38, a display unit 40, a remote control processing module 20b, a transmitter 32b, a display processing module 40, an input interface 34 and an output interface 50. The remote control processing module 20b comprises a coordinate calculator 22b, a graphic generating unit 24, an indication module 28 and a transmission generator 30. The remote controller 14b comprises a command generator 46b, a coordinate generator 48, a receiver 52 and a controller 54. The controller 54 comprises a transmission generator 44b and a recorder 32b. The transmission generator 44b is coupled to the command generator 46b and the recorder 56, which is also coupled to the receiver 52.

Operations of the display system 10b are to be described below.

The menu recorder 38 and the graphic generating unit 24 provide a user interface for universal remote control, such as the screen 100 in FIG. 1. The user then performs the universal remote control via the remote controller 14b with reference to the user interface. For example, by using a touch panel, an arrow (upper, lower, left and right) control buttons, and/or a rotating wheel (not shown), the coordinate generator 48 provides corresponding coordinate information. The command generator 46b is embedded with remote control commands for remote controlling the display processing module 36 and the remote control processing module 20b. For example, the remote control commands may correspond to various buttons on the remote controller 14b, so that the command generator 46b provides command information according to the remote control command corresponding to the button pressed by the user. Next, the transmission generator 44b encodes/packages/carries the coordinate information and command information in the electronic remote control signal Sr0, and the transmitter 42b converts/modulates the remote control signal Sr0 as required and transmits the converted/modulated remote control signal Sr0 as the remote control signal Sr1, which is for example, an infrared or radio frequency remote control signal.

The receiver 16 in the display apparatus 12b receives the remote control signal Sr1 from the remote controller 14b, and demodulates/de-converts it to an electronic remote control signal Sr2. The decoder 18 then decodes/de-packages the remote control signal Sr2 to retrieve the coordinate information and/command information carried therein. With reference to a menu/coordinate regions provided by the menu recorder 38, and corresponding remote controls and peripheral apparatuses, the coordinate calculator 22b compares and determines which graphic or function on the user interface of the display apparatus 12b the user wishes to select according to the coordinate information and/or the command information; that is, to execute which command on which peripheral apparatus. Thus, the indication module 28 carries the remote control command in the transmission signal St0 according to the corresponding transmission signal St0 provided by the remote control command. The transmission generator 30 encodes/packages the transmission signal St0 to generate the transmission signal St1, which is then converted/modulated by the transmitter 32b to the transmission signal St2 to be transmitted. The transmission signal St2 is, for example, an infrared or radio frequency signal.

Upon receiving the transmission signal St2, the receiver 52 in the remote controller 14b provides a corresponding electronic transmission signal St3. According to the transmission signal St3, the recorder 56 provides an electronic remote control signal Sr3 corresponding to the transmission signal St3, and the transmitter 42b provides a remote control signal Sr4 (e.g., an infrared or radio frequency signal) according to the remote control signal Sr3, and transmits the remote control signal Sr4 to the peripheral apparatuses. Thus, the peripheral apparatuses are controlled by the remote control signal Sr4 to realize universal remote control.

More specifically, in the embodiment illustrated by FIG. 2, universal remote control of the display apparatus 12b and the peripheral apparatuses is easily performed via the remote controller 14b. A main difference between the above two embodiments is that, in the display apparatus 12b, the transmission signals St1 and St2 for controlling the peripheral apparatuses are relayed by the remote control signals Sr3 and Sr4 of the remote controller 14b to the peripheral apparatuses PD1 to PD4. In some applications, relative positions of the display apparatus 12b and the peripheral apparatuses may result in a situation that the transmission signal St2 (e.g., an infrared transmission signal St2) of the display apparatus 12 may not be successfully transmitted to the peripheral apparatuses. However, since the peripheral apparatuses are arranged around the user, transmission paths between the peripheral apparatuses and the remote controller 14b that the user carries are likely to be quite direct with minimal obstructions, and so the remote control 14b of the embodiments of the present invention is thus made suitable for relaying the remote control commands of the peripheral apparatuses.

Remote control signals acceptable to different peripheral apparatuses carry remote control commands in different formats. For example, a remote control signal acceptable to the peripheral apparatus PD1 is encoded/modulated in a first format, and a remote control signal acceptable to the peripheral apparatus PD2 is encoded/modulated in a second format. Hence, it is necessary that the remote control signals to be transmitted to the peripheral apparatuses PD1 and PD2 be respectively compliant to the first format and the second format for universal remote control. In another embodiment of the present invention, when the remote controller 14b relays remote control commands of different peripheral apparatuses with the remote control signal Sr4, the transmission generator 44b in the remote controller 14b is built-in with various remote control formats, so that the remote control commands of the different peripheral apparatuses are carried in the remote control signal Sr4 according to corresponding formats.

In another embodiment of the remote controller 14b, the receiver 52 is capable of capturing waveform characteristics of the transmission signal St2, and reflects the captured waveform characteristics in the transmission signal St3. The recorder 56 is correspondingly a waveform recorder that provides/records transmission information according to the waveform characteristics (e.g., waveform characteristics of the first transmission signal) to the transmission generator 44b. The transmission generator 44b, as a waveform generator, enables the transmitter 42b to reconstruct a remote control signal Sr4 substantially identical to the transmission signal St2 according to the waveform characteristics recorded in the transmission information. In this embodiment, when the display apparatus 12b provides a corresponding signal St2 according to a remote control command of a particular peripheral apparatus, the transmission signal St2 is provided in a way that it is compliant to the format of the peripheral apparatus. Therefore, it is not necessary for the remote controller 14b to decode the remote control command in the transmission signal St2. It is only required to copy the waveforms of the transmission signal St2 in the remote control signal Sr4.

Thus, this embodiment is capable of simplifying a structure of the remote controller 14b to reduce its cost.

In another embodiment of the invention, a peripheral apparatus to be remote controlled is selected via the remote control menu, and the peripheral apparatus is directly selected using the remote controller 14b. With reference of the remote control menu displayed by the display apparatus 12b, direct operations are performed on the remote controller 14b; for example, a coordinate region representing a predetermined peripheral apparatus (e.g., one of the peripheral apparatuses PD1 to PD4) is directly selected on the remote control menu, and the corresponding coordinate information is transmitted to the display apparatus 12b via the remote control signal Sr0/Sr1 by the remote controller 14b. According to the coordinate arrangement of the coordinate information and the remote control menu, the remote control processing module 20b determines the peripheral apparatus that the user wishes to remote control, and transmits the transmission signal St1/St2 back to the remote controller 14b. Thus, the remote control 14b is notified of the peripheral apparatus that the user wishes to remote control, and is enabled to directly remote control the desired peripheral apparatus via the remote control signal Sr4.

For example, to remote control the desired peripheral apparatus PD1, the peripheral apparatus PD1 is specified via the remote control menu, so that the remote controller 14b becomes the remote controller of the peripheral apparatus PD1 that is then directly remote controllable by the remote controller 14b. When the desired peripheral apparatus is switched from PD1 to PD2, the peripheral apparatus PD2 is again specified via the remote control menu on the display apparatus 12b. Under the control of the remote control processing module 20b, the remote controller 14b becomes the remote controller of the peripheral apparatus PD2, and then is enabled to directly control the peripheral apparatus PD2.

In this embodiment, the remote controller 14b is built-in with remote control commands and corresponding remote control signals formats and/or waveform characteristics of different peripheral apparatuses (e.g., PD1 to PD4), so as to directly remote control the peripheral apparatuses. Alternatively, when the remote controller 14b is to serve as a remote controller of a specific peripheral apparatus, the display apparatus 12b may transmit the remote control commands and the corresponding remote control signal formats and/or waveform characteristics of the peripheral apparatus via the transmission signal St2, so that the remote controller 14b is enabled to utilize the information to remote control the peripheral apparatus.

Compared to the remote controller 14b, the display apparatus 12b is capable of easily accommodating various format requirements of the various peripheral apparatuses since it is readily equipped with powerful signal storage/processing capabilities as well as hardware/software operation resources. For example, the remote control processing module 20b in the display apparatus 12b is embedded with formats corresponding to the various peripheral apparatuses, such that the transmission signal St2 with corresponding formats may be transmitted to the various peripheral apparatuses by the transmission generator 30/the transmitter 32b. Further, the remote control processing module 20b (and 20a) may also record waveform characteristics of remote control signals corresponding to the remote control commands of the various peripheral apparatuses, so that when it is desired that a predetermined remote control command be sent to a certain peripheral apparatus, a corresponding transmission signal St2 may be reconstructed according to the remote control signal waveform characteristics corresponding to the remote control command.

In the embodiment illustrated in FIG. 2, the remote control signals Sr1 and Sr4 transmitted by the transmitter 42b may be the same or different remote signals; for example, the remote control signals Sr1 and Sr4 are infrared remote control signals. In another embodiment, the remote control signal Sr1 is an infrared remote control signal, whereas the remote control signal Sr4 is a radio frequency remote control signal; and the transmitter 42b is correspondingly capable of infrared and radio frequency remote control signal transmissions.

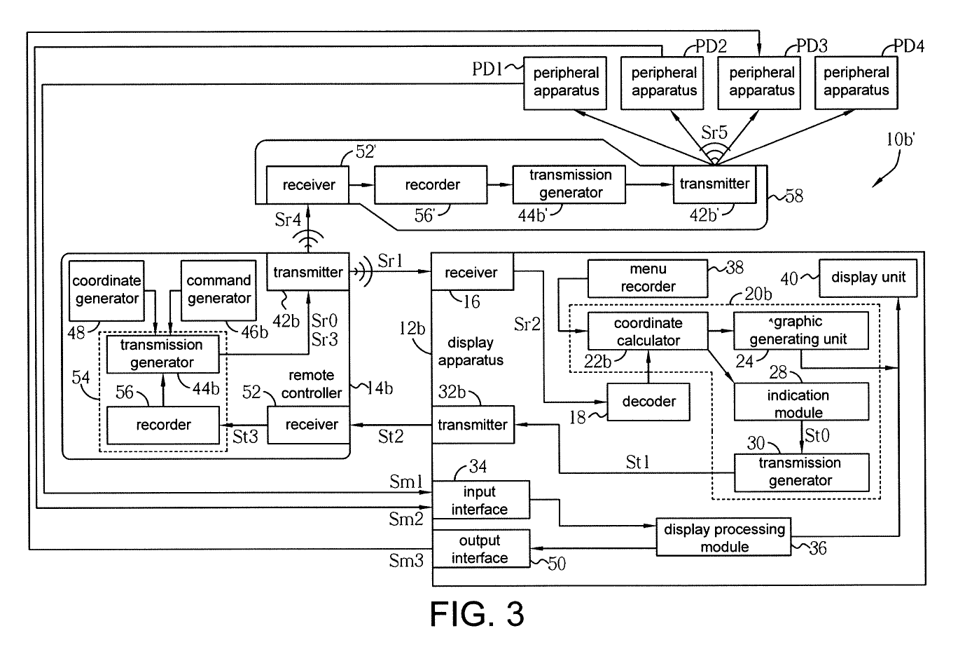

A display system 10b′ in FIG. 3 is derived from the display system 10b shown in FIG. 2. In the display system 10b′, apart from comprising the previous display apparatus 12b and remote controller 14b, further comprises one or a plurality of relay devices. In FIG. 3, a relay device 58 is taken as an example. As stated in the previous description, to perform universal remote control, the display apparatus 12b carries the remote control signals to be transmitted to the peripheral apparatus in the transmission signal St2, and the remote controller 14b provides the remote control signal Sr4 according to the transmission signal St2. However, in some applications, preferred transmission paths between the remote controller 14b and certain peripheral apparatuses may be unavailable—the relay device 58 is then utilized to relay the remote control signal Sr4 in such situations. The relay device 58 provides a remote control signal Sr5 according to the remote control signal Sr4, then the remote control signal Sr5 is successfully transmitted to the peripheral apparatuses to achieve universal remote control.

In the embodiment shown in FIG. 3, the relay device 58 comprises a receiver 52′, a recorder 56′, a transmission generator 44b′, and a transmitter 42′, which function similarly to the receiver 52, the recorder 56, the transmission generator 44b, and the transmitter 42, respectively. In one embodiment, the receiver 52′ receives the remote control signal Sr4 and retrieves waveform characteristics of the remote control signal Sr4. The recorder 56′ provides transmission information to the transmission generator 44b′, which reconstructs the remote control signal Sr5 according to the waveform characteristics of the remote control signal Sr4, followed by the transmitter 42b′ transmitting the remote control signal Sr5 to the peripheral apparatuses. In the event that transmission ranges of the remote control signals Sr4 and Sr5 do not cover all of the peripheral apparatuses, one or a plurality of additional relay devices may be implemented to provide subsequent remote control signals according to the remote control signal Sr4 and/or Sr5, so that the remote control signal Sr4 can be successfully relayed to the peripheral apparatuses.

In the embodiment shown in FIG. 3, the remote controller 14b and the relay device 58 comprise the same signal relay structure of the transmitter 52/52′, the recorder 56/56′, the transmission generator 44b/44b′, and the transmitter 42b/42b′. Therefore, the remote controller 14b can also be regarded as a relay device.

In the display apparatus of the present invention, the remote control processing module learns the remote control signals transmitted from different dedicated remote controllers of the peripheral apparatuses, and enables the user to associate the remote control signals/commands to the corresponding remote control menu/coordinate regions/peripheral apparatuses via the user interface provided by the remote control processing module and the display unit. Taking FIG. 2 for example, for the peripheral apparatus PD1, a predetermined button on the dedicated remote controller (not shown) of the peripheral apparatus PD1 is pressed so that the receiver 16 in the display apparatus 12b receives the corresponding remote control signal transmitted from the dedicated remote controller. Next, by setting with the remote controller 14b, the remote control signal is associated with the corresponding display apparatus, remote control command, remote control menu and/or coordinate regions. In one embodiment, the remote control processing module 20b parses a format and command information carried in the remote control signal transmitted by the dedicated remote controller, and associates the command information to the user setting when the user defines settings with the universal remote controller. Hence, when the remote control signal is triggered according to previous settings, the remote control processing module 20b carries the corresponding command information in the corresponding format in the remote control signal Sr2. In another embodiment, the remote control processing module 20b captures the waveform characteristics from the remote control signal transmitted from the dedicated remote controller and records the captured waveform characteristics, which are regarded as the command information of the remote controller and are associated with the user settings. Hence, when the remote control signal is triggered according to previous settings, the remote control processing module 20b provides the waveform characteristics, so that the transmitter 32b is enabled to reconstruct the remote control signal in the transmission signal St2.

In conclusion, being distinctive from the prior art, the present invention realizes universal remote control by utilizing readily available functions as well as hardware and software operation resources of a display apparatus. Not only a structure is simplified and cost is reduced for a remote controller, but also a highly customized, a more intuitive, user-friendly and diversified and richer user interface is offered. Further, the remote control processing module may be realized by hardware with corresponding software and/or firmware.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display apparatus, coupled to a plurality of peripheral apparatuses, for displaying a media signal from one of the peripheral apparatuses, the display apparatus comprising:
a receiver configured to receive a remote control signal;
a remote control processing module, coupled to the receiver, configured to provide a remote control menu corresponding to the peripheral apparatuses; and
a display unit, coupled to the remote control processing unit, configured to display the remote control menu in response to the remote control signal to generate a remote control operation corresponding to one of the peripheral apparatuses.

2. The display apparatus according to claim 1, wherein the remote control menu is configurable by the remote control signal.

3. The display apparatus according to claim 2, further comprising:
a menu recorder, coupled to the remote control processing module, configured to record a coordinate configuration corresponding to the remote control menu, comprising a plurality coordinate positions and corresponding remote control commands; wherein, each of the remote control commands is associated with one of the peripheral apparatuses

4. The display apparatus according to claim 3, wherein the remote control signal carries coordinate information, and the remote control processing module comprises:
a coordinate calculator, coupled to the receiver, configured to compare the coordinate information with the coordinate positions to determine a matching coordinate position; and
an indication module, coupled to the coordinate calculator, configured to provide a transmission signal corresponding to the remote control command according to the matching coordinate position.

5. The display apparatus according to claim 4, further comprising:
a transmitter configured to transmit the transmission signal to the peripheral apparatus that is associated with the corresponding remote control signal.

6. The display apparatus according to claim 4, further comprising:
a transmitter configured to transmit the transmission signal to the remote controller.

7. The display apparatus according to claim 3, wherein the remote control processing module further comprises:
a graphic generating unit configured to respectively provide the coordinate positions a corresponding graphic, for the display unit to display the remote control menu.

8. The display apparatus according to claim 1, wherein the remote control signal carries command information, and the remote control processing module comprises:
a command comparator, coupled to the receiver, configured to compare the command information with a plurality of remote control commands corresponding to one of the peripheral apparatuses and determine a matching remote control command; and
an indication module configured to provide a transmission signal according to the matching remote control command.

9. A universal remote controller, for remote controlling a display apparatus and a plurality of peripheral apparatuses, comprising:
a transmitter configured to transmit a remote control signal to the display apparatus;
a receiver, for receiving a first transmission signal corresponding to the remote control signal from display apparatus;
a controller, coupled to the transmitter and the receiver, configured to provide a corresponding second transmission signal to be transmitted by the transmitter according to the first transmission signal; and
a coordinate generator configured to provide coordination information associated with the remote control signal.

10. The remote controller according to claim 9, wherein the remote controller comprises:
a recorder, coupled to the receiver, configured to provide first transmission information according to the first transmission signal; and
a transmission generator, coupled to the transmitter and the recorder, configured to provide the second transmission signal according to the first transmission information.

11. The remote controller according to claim 10, further comprising:
a command generator, coupled to the transmission generator, configured to provide command information, according to which the transmission generator provides the remote control signal to the transmitter.

12. A display system, for operating a plurality of peripheral apparatuses, the display system comprising:
a display apparatus, comprising:
a first receiver configured to receive a first remote control signal to set a corresponding remote control menu;
a display unit configured to display a media signal from one of the peripheral apparatuses and the remote control menu; and
a first transmitter configured to transmit a first transmission signal according to the remote control signal; and
a remote controller configured to remote control the display apparatus, comprising:
a plurality of function keys;
a second receiver configured to receive the first transmission signal;
a second transmitter configured to transmit the remote control signal, and transmit a second transmission signal to one of the peripheral apparatuses according to the first transmission signal; and
a coordinate generator configured to provide coordinate information of the function keys;
wherein, the remote control signal is associated with the coordinate information, and the remote control menu is associated with the coordinate information and the peripheral apparatuses.
